(19) United States
(12) Patent Application Publication
(10) Pub. No.: US 2026/0188319 A1
(43) Pub. Date: Jul. 2, 2026

(54) ELECTRONIC DEVICE AND METHOD OF PROCESSING USER UTTERANCE

(71) Applicant: Samsung Electronics Co., Ltd., Suwon-si (KR)

(72) Inventor: Jihoon JANG, Suwon-si (KR)

(21) Appl. No.: 19/544,115

(22) Filed: Feb. 19, 2026

Related U.S. Application Data
(63) Continuation of application No. PCT/KR2024/011474, filed on Aug. 5, 2024.

(30) Foreign Application Priority Data
Sep. 11, 2023 (KR) 10-2023-0120545
Oct. 5, 2023 (KR) 10-2023-0132841

(51) Int. Cl. G10L 15/22; G10L 15/18; G10L 15/183; G10L 15/30

(52) U.S. Cl. CPC G10L 15/22; G10L 15/1815; G10L 15/183; G10L 2015/223; G10L 15/30

(57) ABSTRACT

A method for operating an electronic device is provided. The method includes receiving, by the electronic device, a user input, obtaining, by the electronic device, information about a task corresponding to the input, based on the information, obtaining, a list including pre-conditions to be satisfied in order to perform the task and sub-operations to be sequentially performed in order to perform the task, and based on whether the pre-conditions are satisfied, optionally performing, by the electronic device, at least some of the sub-operations.

### CROSS-REFERENCE TO RELATED APPLICATION(S)

This application is a continuation application, claiming priority under 35 U.S.C. § 365(c), of an International application No. PCT/KR2024/011474, filed on August 5, 2024, which is based on and claims the benefit of a Korean patent application number 10-2023-0120545, filed on September 11, 2023, in the Ministry of Intellectual Property (MOIP), and of a Korean patent application number 10-2023-0132841, filed on October 5, 2023, in the Ministry of Intellectual Property (MOIP), the disclosure of each of which is incorporated by reference herein in its entirety.

### BACKGROUND

### 1. Field

The disclosure relates to an electronic device and a method of processing a user utterance.

### 2. Description of Related Art

Electronic devices equipped with a voice assistant function that provides services based on user utterances have been widely deployed. An electronic device may recognize a user's utterance through an artificial intelligence (AI) server and may understand the meaning and intent of the utterance. The AI server may interpret the user's utterance to infer the user's intent and may perform tasks according to the inferred intent. The AI server may perform tasks based on the user's intent expressed through natural language interactions between the user and the AI server.

An electronic device equipped with a voice assistant function may perform an operation of classifying domains for processing a user utterance and an operation of performing a task corresponding to the user utterance in a classified domain (e.g., a capsule) (e.g., an application) in a time series.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method of processing a user utterance.

Additional aspects will be set forth in part in the description which follows and, in part, will be apparent from the description, or may be learned by practice of the presented embodiments.

In accordance with an aspect of the disclosure, a method of operating an electronic device is provided. The method includes receiving, by the electronic device, an input of a user, obtaining, by the electronic device, information regarding a task corresponding to the input, based on the information, obtaining, by the electronic device, a list including pre-conditions to be satisfied to perform the task and sub-operations to be sequentially performed to perform the task, and based on whether the pre-conditions are satisfied, optionally performing, by the electronic device, at least some of the sub-operations.

In accordance with another aspect of the disclosure, an electronic device is provided. The electronic device includes memory, comprising one or more storage media, storing instructions, and one or more processors communicatively coupled to the memory, wherein the instructions, when executed by the one or more processors individually or collectively, cause the electronic device to receive an input of a user, obtain information regarding a task corresponding to the input, based on the information, obtain a list including pre-conditions to be satisfied to perform the task and sub-operations to be sequentially performed to perform the task, and based on whether the pre-conditions are satisfied, optionally perform at least some of the sub-operations.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, an input of a user, obtaining, by the electronic device, information regarding a task corresponding to the input, based on the information, obtaining, by the electronic device, a list comprising pre-conditions to be satisfied to perform the task and sub-operations to be sequentially performed to perform the task, and based on whether the pre-conditions are satisfied, optionally performing, by the electronic device, at least some of the sub-operations.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating an integrated intelligence system according to an embodiment of the disclosure;

FIG. 3 is a diagram illustrating a form in which relationship information between concepts and actions is stored in a database (DB), according to an embodiment of the disclosure;

FIG. 4 is a diagram illustrating a screen of an electronic device processing a received voice input through an intelligent app, according to an embodiment of the disclosure;

FIG. 5 is a diagram illustrating an operation of an electronic device processing an utterance of a user, according to an embodiment of the disclosure;

FIG. 6 is a schematic block diagram of an electronic device according to an embodiment of the disclosure;

FIG. 7 is a diagram illustrating new task lists according to an embodiment of the disclosure;

FIGS. 8A, 8B, 9A, 9B, 9C, 9D, 10A, 10B, and 11 are diagrams illustrating an operation of an electronic device processing a user utterance, according to various embodiments of the disclosure; and

FIG. 12 is a flowchart of a method of operating an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

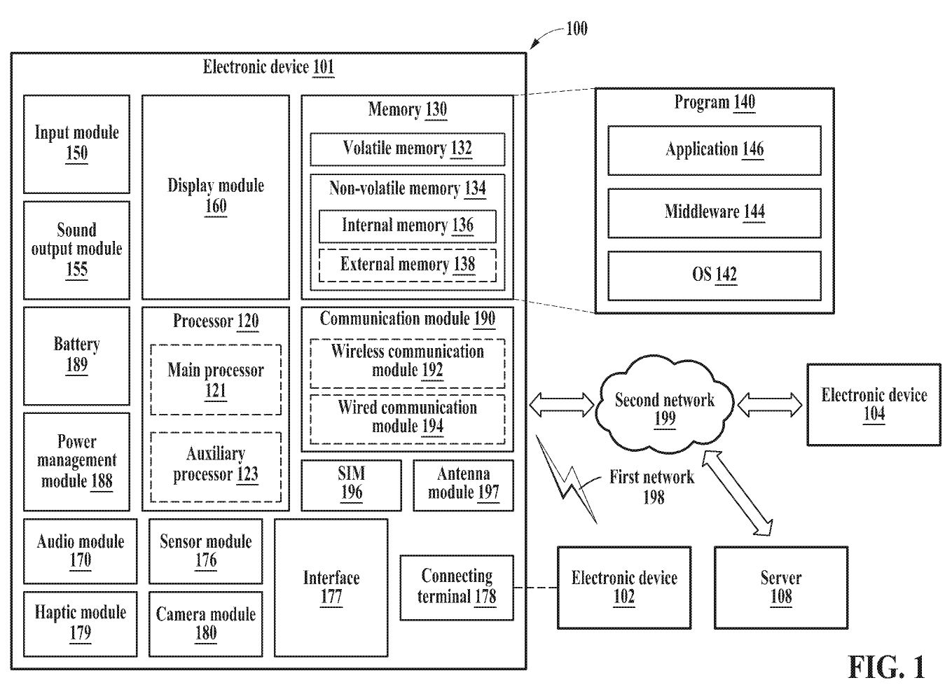

FIG. 1 is a block diagram of an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is an activated state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for artificial intelligence (AI) model processing. An AI model may be generated by machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic apparatus 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., the electronic device 102) (e.g., a speaker or headphone) directly or wirelessly connected to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

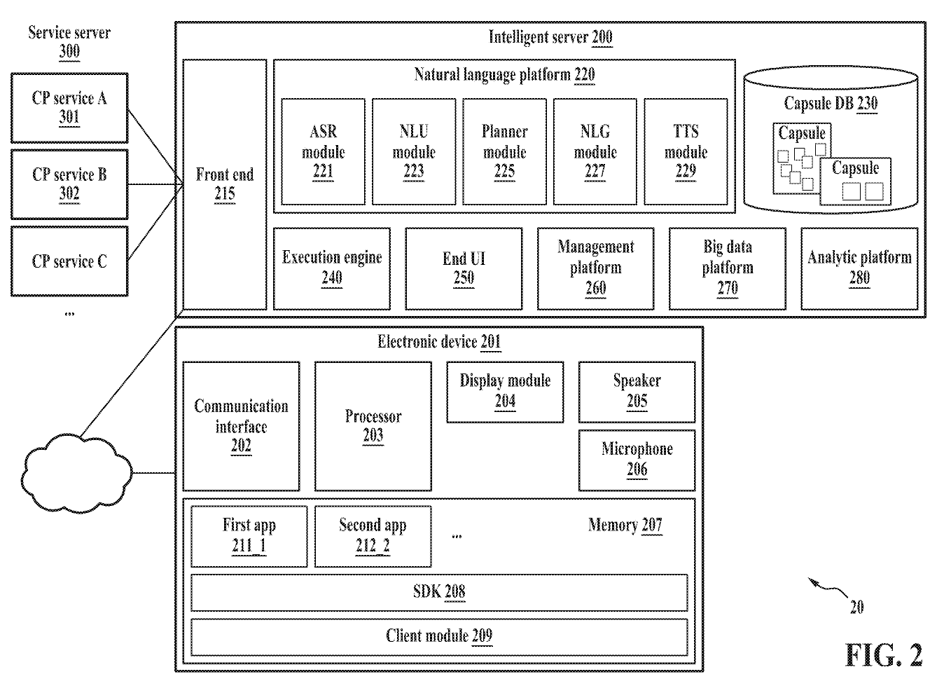

FIG. 2 is a block diagram illustrating an integrated intelligence system according to an embodiment of the disclosure.

Referring to FIG. 2, an integrated intelligence system 20 according to an embodiment may include an electronic device 201 (e.g., the electronic device 101 of FIG. 1), an intelligent server 200 (e.g., the server 108 of FIG. 1), and a service server 300 (e.g., the server 108 of FIG. 1).

The electronic device 201 according to an embodiment may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the shown embodiment, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), memory 207 (e.g., the memory 130 of FIG. 1), or a processor 203 (e.g., the processor 120 of FIG. 1). The components listed above may be operationally or electrically connected to one another.

The communication interface 202 according to an embodiment may be connected to an external device and configured to transmit and receive data to and from the external device. The microphone 206 according to an embodiment may receive a sound (e.g., a user utterance) and convert the sound into an electrical signal. The speaker 205 according to an embodiment may output the electrical signal as a sound (e.g., a speech).

The display module 204 according to an embodiment may be configured to display an image or video. The display module 204 according to an embodiment may also display a graphical user interface (GUI) of an app (or an application program) being executed. The display module 204 of an embodiment may receive a touch input through a touch sensor. For example, the display module 204 may receive a text input through a touch sensor in an on-screen keyboard area displayed in the display module 204.

The memory 207 may store a client module 209, a software development kit (SDK) 208, and a plurality of apps 211. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of apps 211 stored in the memory 207 may be programs for performing designated functions. According to an embodiment, the plurality of apps 211 may include a first app 211_1 and a second app 211_2. According to an embodiment, each of the plurality of apps 211 may include a plurality of actions for performing a designated function. For example, the apps may include an alarm app, a messaging app, and/or a scheduling app. According to an embodiment, the plurality of apps 211 may be executed by the processor 203 to sequentially execute at least a portion of the plurality of actions.

The processor 203 according to an embodiment may control the overall operation of the electronic device 201. For example, the processor 203 may be electrically connected to the communication interface 202, the microphone 206, the speaker 205, and the display module 204 to perform a designated action.

The processor 203 according to an embodiment may also perform the designated function by executing the program stored in the memory 207. For example, the processor 203 may execute at least one of the client module 209 or the SDK 208 to perform the following operation for processing a user input. The processor 203 may control the actions of the plurality of apps 211 through, for example, the SDK 208. The following operation which is the operation of the client module 209 or the SDK 208 may be performed by the processor 203.

The client module 209 according to an embodiment may receive a user input. For example, the client module 209 may receive a speech signal corresponding to a user utterance sensed through the microphone 206. Alternatively, the client module 209 may receive a touch input sensed through the display module 204. Alternatively, the client module 209 may receive a text input sensed through a keyboard or an on-screen keyboard. In addition, the client module 209 may receive various types of user inputs sensed through an input module included in the electronic device 201 or an input module connected to the electronic device 201. The client module 209 may transmit the received user input to the intelligent server 200. The client module 209 may transmit state information of the electronic device 201 together with the received user input to the intelligent server 200. The state information may be, for example, execution state information of an app.

The client module 209 according to an embodiment may receive a result corresponding to the received user input. For example, when the intelligent server 200 is capable of calculating a result corresponding to the received user input, the client module 209 may receive the result corresponding to the received user input. The client module 209 may display the received result on the display module 204. Furthermore, the client module 209 may output the received result in an audio form through the speaker 205.

The client module 209 according to an embodiment may receive a plan corresponding to the received user input. The client module 209 may display results of executing a plurality of actions of an app according to the plan on the display module 204. For example, the client module 209 may sequentially display the results of executing the plurality of actions on the display module 204 and output the results in an audio form through the speaker 205. In another example, the electronic device 201 may display only a portion of the results of executing the plurality of actions (e.g., a result of the last action) on the display module 204 and output the portion of the results in an audio form through the speaker 205.

According to an embodiment, the client module 209 may receive a request for obtaining information necessary for calculating a result corresponding to the user input from the intelligent server 200. According to an embodiment, the client module 209 may transmit the necessary information to the intelligent server 200 in response to the request.

The client module 209 according to an embodiment may transmit, to the intelligent server 200, information on the results of executing the plurality of actions according to the plan. The intelligent server 200 may confirm that the received user input is correctly processed using the information on the results.

The client module 209 according to an embodiment may include a speech recognition module. According to an embodiment, the client module 209 may recognize a voice input for performing a limited function through the speech recognition module. For example, the client module 209 may execute an intelligent app for processing a voice input to perform an organic operation through a designated input (e.g., Wake up!).

The intelligent server 200 according to an embodiment may receive information related to a user voice input from the electronic device 201 through a communication network. According to an embodiment, the intelligent server 200 may change data related to the received voice input into text data. According to an embodiment, the intelligent server 200 may generate a plan for performing a task corresponding to the user voice input based on the text data.

According to an embodiment, the plan may be generated by an AI system. The AI system may be a rule-based system or a neural network-based system (e.g., a feedforward neural network (FNN) or a recurrent neural network (RNN)). Alternatively, the AI system may be a combination of the above-described systems or other AI systems. According to an embodiment, the plan may be selected from a set of predefined plans or may be generated in real time in response to a user request. For example, the AI system may select at least one plan from the pre-defined plans.

The intelligent server 200 according to an embodiment may transmit a result according to the generated plan to the electronic device 201 or transmit the generated plan to the electronic device 201. According to an embodiment, the electronic device 201 may display the result according to the plan on the display module 204. According to an embodiment, the electronic device 201 may display a result of executing an action according to the plan on the display module 204.

The intelligent server 200 may include a front end 215, a natural language platform 220, a capsule database (DB) 230, an execution engine 240, an end UI 250, a management platform 260, a big data platform 270, or an analytic platform 280.

The front end 215 according to an embodiment may receive the received user input from the electronic device 201. The front end 215 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 according to an embodiment may convert data related to a voice input received from the electronic device 201 into text data. The NLU module 223 according to an embodiment may discern an intent of a user using the text data of the voice input. For example, the NLU module 223 may discern an intent of a user by performing syntactic analysis or semantic analysis on a user input in the form of text data. The NLU module 223 according to an embodiment may discern the meaning of a word extracted from the user input using a linguistic feature (e.g., a grammatical element) of a morpheme or phrase and determine the intent of the user by matching the discerned meaning of the word to an intent. In other words, the NLU module 223 may obtain intent information corresponding to a user utterance. The intent information may be information indicating the intent of the user determined through an analysis of the text data. The intent information may include information indicating an action (or function) that the user intends to execute using a device. The intent information may be referred to as goal information. A slot may be detailed information associated with intent information. The slot may be a parameter needed to perform an action based on the intent of the user. The slot may be obtained based on a domain corresponding to an utterance. The slot may be variable information necessary to perform an action.

The planner module 225 according to an embodiment may generate a plan using a parameter (e.g., a slot) and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions, or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically). For example, based on the plurality of concepts, the planner module 225 may determine an execution order of the plurality of actions determined based on the intent of the user. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 according to an embodiment may change designated information into a text form. The information changed to the text form may be in the form of a natural language utterance. The TTS module 229 according to an embodiment may change information in a text form into information in a speech form.

According to an embodiment, some or all of the functions of the natural language platform 220 may be implemented in the electronic device 201 as well.

The capsule DB 230 may store information on the relationships between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there is a plurality of plans corresponding to the user input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 201. According to an embodiment, the capsule DB 230 may include a vocabulary registry that stores vocabulary information included in capsule information. According to an embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with a user. The developer tool may include a follow-up editor capable of activating a follow-up goal and editing a follow-up utterance that provides a hint. The follow-up goal may be determined based on a currently set goal, a preference of a user, or an environmental condition. In an embodiment, the capsule DB 230 may be implemented in the electronic device 201 as well.

The execution engine 240 according to an embodiment may calculate a result using the generated plan. The end UI 250 may transmit the calculated result to the electronic device 201. Accordingly, the electronic device 201 may receive the result and provide the received result to the user. The management platform 260 according to an embodiment may manage information used by the intelligent server 200. The big data platform 270 according to an embodiment may collect data of the user. The analytic platform 280 according to an embodiment may manage a quality of service (QoS) of the intelligent server 200. For example, the analytic platform 280 may manage the components and processing rate (or efficiency) of the intelligent server 200.

The service server 300 according to an embodiment may provide a designated service (e.g., food order or hotel reservation) to the electronic device 201. According to an embodiment, the service server 300 may be a server operated by a library server. The service server 300, including a CP service A 301 and a CP service B 302, may interact with a front end 210 of the intelligent server 200. The service server 300 according to an embodiment may provide information to be used for generating a plan corresponding to the received user input to the intelligent server 200. The provided information may be stored in the capsule DB 230. In addition, the service server 300 may provide result information according to the plan to the intelligent server 200.

In the integrated intelligence system 20 described above, the electronic device 201 may provide various intelligent services to the user in response to a user input. The user input may include, for example, an input through a physical button, a touch input, or a voice input.

In an embodiment, the electronic device 201 may provide a speech recognition service through an intelligent app (or a speech recognition app) stored therein. In this case, for example, the electronic device 201 may recognize a user utterance or a voice input received through the microphone and provide a service corresponding to the recognized voice input to the user.

In an embodiment, the electronic device 201 may perform a designated action alone or together with the intelligent server and/or a service server, based on the received voice input. For example, the electronic device 201 may execute an app corresponding to the received voice input and perform a designated action through the executed app.

In an embodiment, when the electronic device 201 provides a service together with the intelligent server 200 and/or the service server 300, the electronic device 201 may detect a user utterance using the microphone 206 and generate a signal (or voice data) corresponding to the detected user utterance. The electronic device 201 may transmit the voice data to the intelligent server 200 using the communication interface 202.

The intelligent server 200 according to an embodiment may generate, as a response to the voice input received from the electronic device 201, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may be defined as parameters that are input for execution of the plurality of actions or result values that are output by execution of the plurality of actions. The plan may include connection information on connections between the plurality of actions and the plurality of concepts.

The electronic device 201 may receive the response using the communication interface 202. The electronic device 201 may output a speech signal generated inside the electronic device 201 to the outside using the speaker 205 or may output an image generated inside the electronic device 201 to the outside using the display module 204.

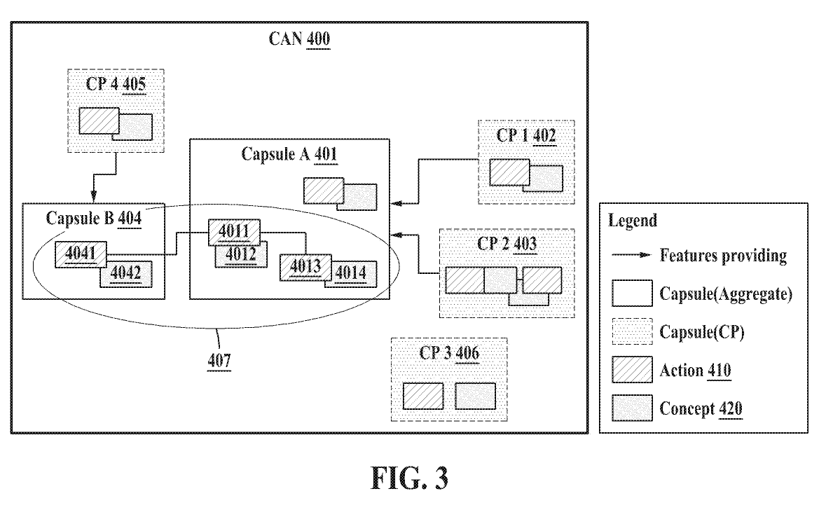

FIG. 3 is a diagram illustrating a form in which relationship information between concepts and actions is stored in a DB, according to an embodiment of the disclosure.

Referring to FIG. 3, a capsule DB (e.g., the capsule DB 230 of FIG. 2) of the intelligent server (e.g., the intelligent server 200 of FIG. 2) may store capsules in the form of a CAN 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains. According to an embodiment, one capsule (e.g., the capsule A 401) may correspond to one domain (e.g., a location (geo)). In addition, one capsule may correspond to at least one service provider (e.g., CP 1 402 or CP 2 403) for performing a function for a domain related to the capsule. According to an embodiment, one capsule may include at least one action 410 for performing a designated function and at least one concept 420. The CAN 400 may store other information such as a CP 3406. In addition, the capsule B 404 may correspond to a service provider (e.g., a CP 4 405).

A natural language platform (e.g., the natural language platform 220 of FIG. 2) may generate a plan for performing a task corresponding to the received voice input using the capsules stored in the capsule DB. For example, a planner module (e.g., the planner module 225 of FIG. 2) of the natural language platform may generate a plan using the capsules stored in the capsule DB. For example, a plan 407 may be generated using actions 4011 and 4013 and concepts 4012 and 4014 of the capsule A 401 and an action 4041 and a concept 4042 of the capsule B 404.

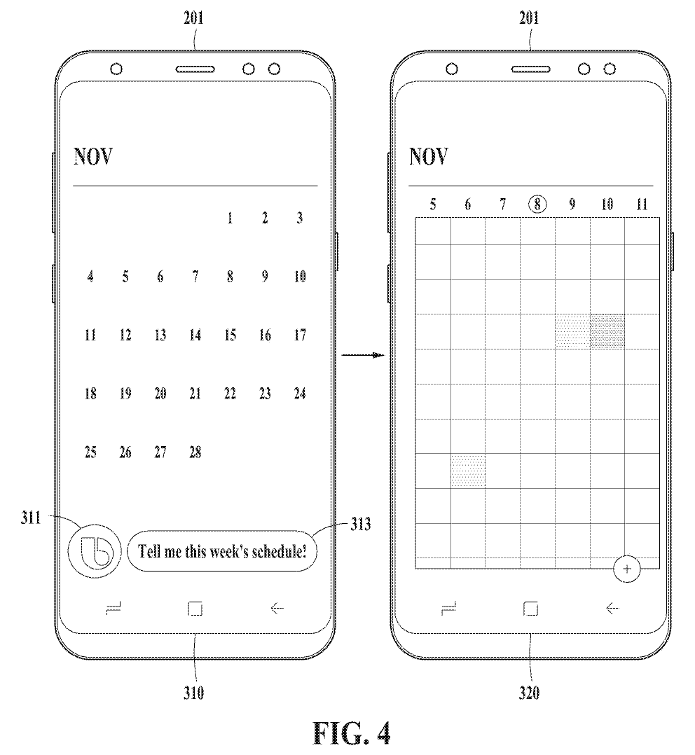

FIG. 4 is a diagram illustrating a screen of an electronic device processing a received voice input through an intelligent app according to an embodiment of the disclosure.

The electronic device 201 may execute an intelligent app to process a user input through an intelligent server (e.g., the intelligent server 200 of FIG. 2).

Referring to FIG. 4, on a screen 310, when a designated voice input (e.g., Wake up!) is recognized or an input through a hardware key (e.g., a dedicated hardware key) is received, the electronic device 201 may execute an intelligent app for processing the voice input. The electronic device 201 may execute the intelligent app, for example, in a state in which a scheduling app is executed. According to an embodiment, the electronic device 201 may display an object (e.g., an icon) 311 corresponding to an intelligent app on the display module 204 (e.g., the display module 160 of FIG. 1 and the display module 204 of FIG. 2). According to an embodiment, the electronic device 201 may receive a voice input by a user utterance. For example, the electronic device 201 may receive a voice input of "Tell me this week's schedule." According to an embodiment, the electronic device 201 may display a UI 313 (e.g., an input window) of the intelligent app in which text data of the received voice input is displayed on the display module 204.

According to an embodiment, on a screen 320, the electronic device 201 may display a result corresponding to the received voice input on the display module 204. For example, the electronic device 201 may receive a plan corresponding to the received user input and display "this week's schedule" on the display module 204 according to the plan.

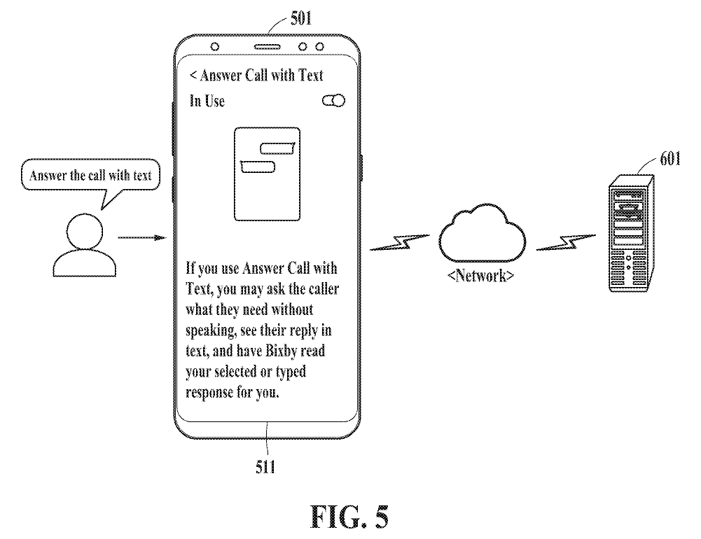

FIG. 5 is a diagram illustrating an operation of an electronic device processing an utterance of a user, according to an embodiment of the disclosure.

Referring to FIG. 5, according to an embodiment, an electronic device 501 may include some of the components of the electronic device 101 described with reference to FIG. 1 and the electronic device 201 described with reference to FIG. 2. An intelligent server 601 may include some of the components of the intelligent server 200 described with reference to FIG. 2. With respect to the electronic device 501 and the intelligent server 601, repeated descriptions provided with reference to FIGS. 1 to 4 are omitted.

According to an embodiment, the electronic device 501 (e.g., the electronic device 101 of FIG. 1 or the electronic device 201 of FIG. 2) may be connected to the intelligent server 601 (e.g., the intelligent server 200 of FIG. 2) via a LAN, a WAN, a value-added network (VAN), a mobile radio communication network, a satellite communication network, or any combination thereof. The electronic device 501 and the intelligent server 601 may communicate with each other through a wired communication method or a wireless communication method (e.g., a wireless LAN (Wi-Fi), Bluetooth, Bluetooth low energy (BLE), ZigBee, Wi-Fi Direct (WFD), ultra-wideband (UWB), IrDA, and near-field communication (NFC)). The electronic device 501 may communicate with a nearby device (e.g., the electronic device 102 of FIG. 1 or the electronic device 104 of FIG. 1) positioned around the electronic device 501.

According to an embodiment, the electronic device 501 may be implemented as at least one of a smartphone, a tablet personal computer (PC), a mobile phone, a speaker (e.g., an AI speaker), a video phone, an e-book reader, a desktop PC, a laptop PC, a netbook computer, a workstation, a server, a PDA, a portable multimedia player (PMP), an MP3 player, a mobile medical device, a camera, or a wearable device.

According to an embodiment, the electronic device 501 may obtain a speech signal corresponding to an utterance of a user and transmit the speech signal to the intelligent server 601. Based on the speech signal, the intelligent server 601 may obtain text data corresponding to the utterance of the user. The text data may be obtained by performing ASR on the speech signal and converting a speech portion into computer-readable text. The intelligent server 601 may analyze the utterance of the user using the text data. Using an analysis result (e.g., intent information, a domain, and/or a capsule), the intelligent server 601 may perform a required function or provide, to a device (e.g., the electronic device 501), a response (e.g., a question and an answer) to be provided to the user. The intelligent server 601 may be implemented as software. A portion or entirety of the intelligent server 601 may be implemented in the electronic device 501. In other words, on-device AI for processing an utterance without communication with the intelligent server 601 may be installed on the electronic device 501. Components, such as the natural language platform 220 described with reference to FIGS. 2 to 4, may be implemented in the electronic device 501.

According to an embodiment, the electronic device 501 may convert a user utterance into text data through an ASR module (e.g., the ASR module 221 of FIG. 2). The electronic device 501 may determine a domain (and/or intent information) corresponding to the user utterance based on the text data through an NLU model (e.g., the NLU model 223 of FIG. 2).

According to an embodiment, a domain may correspond to a category (or a service) associated with an action (or a function) that a user intends to execute using a device. A domain may be categorized based on a provided service. For example, a music play domain may support a music play service (e.g., a music play service including the Melon app and the Spotify app). For example, a communication domain may support a communication service (e.g., a communication service including a messaging app, a chat app, and an email app). User utterances may be respectively processed based on corresponding domains. A task corresponding to a user utterance may be processed in a capsule (e.g., an application). One capsule may correspond to one domain. One capsule may include at least one action for performing a designated function and at least one concept. Based on intent information, a capsule may process a task corresponding to a user utterance. The intent information may be determined in a capsule or an NLU module.

According to an embodiment, intent information may be information indicating the intent of a user determined through interpretation of text data. Intent information may include information indicating an action (or a function) that a user intends to execute using a terminal. Intent information may be referred to as goal information.

According to an embodiment, a slot may be detailed information associated with intent information. A slot may be a parameter required to execute an action according to the intent of a user. For example, when the text converted from a voice input of a user is "What time is it in San Francisco?", the domain may be a 'date & time domain,' the intent information may correspond to 'providing date/time information,' the slot may be 'San Francisco,' and the capsule (e.g., an application) may provide the user with the current time in San Francisco. For example, when the text converted from a voice input of the user is "What's the weather here?", the domain may be a 'weather domain,' the intent information may correspond to 'providing weather information,' the slot may be 'current location,' and the capsule may provide the user with the weather at the current location. For example, when the text converted from a voice input of the user is "Set the oven temperature to 300 degrees," the domain may be a 'device control domain,' the intent information may correspond to 'controlling the oven,' the slot may be '300 degrees,' and the capsule may attempt to set the temperature of the oven to 300 degrees.

According to an embodiment, as described above, the electronic device 501 may perform a task in response to a user input. The task may be an action or function performed to respond to the user input. The task may be a unit designated by the manufacturer of the electronic device 501 or the like. The electronic device 501 may perform (or support) a task that requires satisfaction of pre-conditions.

According to an embodiment, a pre-condition may need to be satisfied to perform a task. The conditions that need to be satisfied to perform a task may vary. Among the conditions, a pre-condition may be a condition that is defined by the manufacturer of the electronic device 501. The manufacturer of the electronic device 501 may define, as pre-conditions, among the conditions, conditions that require a change in user settings and/or conditions that require an active action by the user. For example, to perform a task corresponding to 'answer a call with text,' the condition that needs to be satisfied may be that 'the setting for answering a call with text needs to be allowed.' The manufacturer of the electronic device 501 may define, as a pre-condition, the condition that 'the setting for answering a call with text needs to be allowed,' which requires a change in user settings. For example, to perform a task corresponding to 'create a highlight video,' the conditions that need to be satisfied may include: 1) the gallery app needs to be running; 2) photos need to be in the gallery app; and 3) photos need to be selected for a highlight video. The manufacturer of the electronic device 501 may define, as pre-conditions, the conditions 'photos need to be in the gallery app' and 'photos need to be selected for a highlight video,' which require an active user action. The manufacturer of the electronic device 501 may configure the condition 'the gallery app needs to be running' to be performed directly by the electronic device 501 as needed. The manufacturer of the electronic device 501 may define a sub-operation to satisfy the condition 'the gallery app needs to be running.' The manufacturer of the electronic device 501 may define sub-operations to satisfy the pre-conditions 'photos need to be in the gallery app' and 'photos need to be selected for a highlight video.'

According to an embodiment, sub-operations may need to be performed sequentially to perform a task. The sub-operations may be defined by the manufacturer of the electronic device 501. The sub-operations may include an operation to satisfy a pre-condition. In addition, the sub-operations may include an operation to satisfy a condition (e.g., the gallery app needs to be running) that is not defined as a pre-condition but needs to be satisfied to perform a task. Depending on whether pre-conditions are satisfied (e.g., whether required settings are enabled on an electronic device or whether required data is stored in the electronic device), a UI (e.g., a guide) provided to a user by the electronic device may vary.

According to an embodiment, the electronic device 501 may provide a guide to the user throughout a session in which a task is performed. When a new task is completed at least once according to the guide of the electronic device 501 (e.g., all pre-conditions are satisfied), the electronic device 501, upon receiving a user request for the new task again, may execute the new task immediately. The electronic device 501 may enhance the user experience for new tasks.

Referring to FIG. 5, according to an embodiment, the electronic device 501 may receive an input (e.g., an utterance) (e.g., "Answer the call with text") from a user. The utterance (e.g., "Answer the call with text") may correspond to a task (e.g., a task corresponding to 'answer a call with text') that requires satisfaction of a pre-condition (e.g., the setting for answering a call with text needs to be allowed). The electronic device 501 may determine whether the pre-condition (e.g., the setting for answering a call with text needs to be allowed) is satisfied. The pre-condition (e.g., the setting for answering a call with text needs to be allowed) may be unsatisfied. The electronic device 501 may provide a UI 511 (e.g., Answer Call with Text setting screen) to the user based on a deep link to satisfy the pre-condition (e.g., the setting for answering a call with text needs to be allowed). The electronic device 501 may provide a guide to the user throughout the session in which the task (e.g., the task corresponding to 'answer a call with text') is performed.

According to an embodiment, some or all of the operations performed by the electronic device 501 may be performed by the electronic device 501 and/or the intelligent server 601. Hereinafter, the description continues with the assumption that the operations are performed by the electronic device 501.

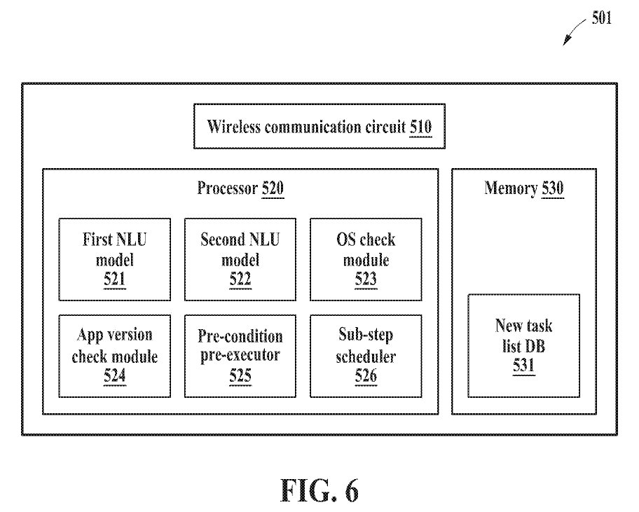

FIG. 6 is a schematic block diagram of an electronic device according to an embodiment of the disclosure.

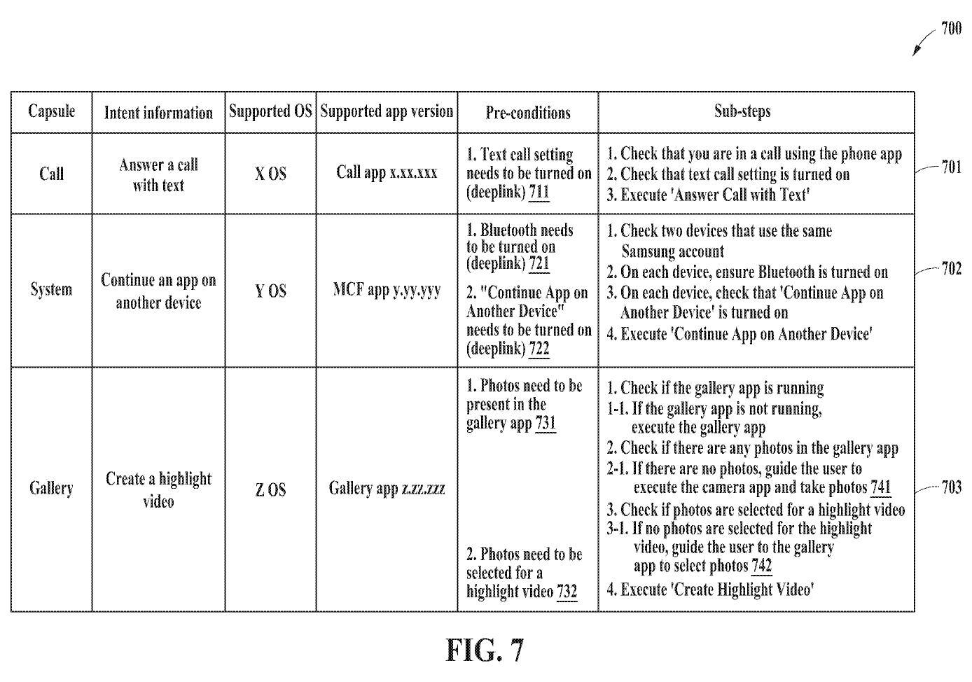

FIG. 7 is a diagram illustrating new task lists according to an embodiment of the disclosure.

Referring to FIG. 6, according to an embodiment, the electronic device 501 may include at least some of the components of the electronic device 101 described with reference to FIG. 1 and the electronic device 201 described with reference to FIG. 2. As described above, on-device AI capable of processing an utterance without communication with an intelligent server (e.g., the intelligent server 200 of FIG. 2 and the intelligent server 601 of FIG. 5) may be installed on the electronic device 501. In other words, the natural language platform 220 described with reference to FIGS. 2 to 4 may be implemented in the electronic device 501. With respect to the electronic device 501, repeated descriptions provided with reference to FIGS. 1 to 4 are omitted.

According to an embodiment, the electronic device 501 may include a wireless communication circuit 510 (e.g., the wireless communication module 192 of FIG. 1). The electronic device 501 may include a processor 520 (e.g., the processor 120 of FIG. 1 and the processor 203 of FIG. 2). The electronic device 501 may include memory 530 (e.g., the memory 130 of FIG. 1 and the memory 207 of FIG. 2). The processor 520 (e.g., an AP) may access the memory 530 to execute one or more instructions. The processor 520 may cause the electronic device 501 to provide a response to a user. The memory 530 may store a variety of data used by at least one component (e.g., the processor 520) of the electronic device 501. The memory 530 may include a new task list DB 531.

According to an embodiment, the processor 520 may be implemented as circuitry (e.g., processing circuitry) such as a system on chip (SoC) or an IC. The processor 520 may include one or more processors. For example, the processor 520 may include a combination of one or more processors such as a CPU, a GPU, a micro processing unit (MPU), an AP, and a CP.

According to an embodiment, the memory 530 may include one or more memories. Instructions stored in the memory 530 may be stored in a single memory. The instructions stored in the memory 530 may be distributed and stored across a plurality of memories. The instructions stored in the memory 530 may be executed by the processor 520 individually or collectively to cause the electronic device 501 to perform and/or control the operations of the electronic device 501 described with reference to FIGS. 5, 6, 7, 8A, 8B, 9A to 9D, 10A, 10B, 11, and 12. The instructions stored in the memory 530 may be executed by a plurality of processors individually or collectively to cause the electronic device 501 to perform and/or control the operations of the electronic device 501 described with reference to FIGS. 5, 6, 7, 8A, 8B, 9A to 9D, 10A, 10B, 11, and 12.

According to an embodiment, the electronic device 501 may receive an input of a user. Based on a first NLU model 521 or a second NLU model 522, the electronic device 501 may determine a task corresponding to the input of the user. The first NLU model 521 may correspond to at least a part of the NLU module 223 of FIG. 2. For example, when the task corresponding to the input of the user is a task that does not require satisfaction of a pre-condition, the electronic device 501 may perform the task through the first NLU model 521, and when the task corresponding to the input of the user is a task that requires satisfaction of a pre-condition, the electronic device 501 may perform the task through the second NLU model 522. For example, when the electronic device 501 fails while performing a task determined through the first NLU model 521 (e.g., because a pre-condition is unsatisfied), the electronic device 501 may continue performing the task through the second NLU model 522 (e.g., by providing a guide to satisfy a pre-condition and performing sub-operations to satisfy the pre-condition). The second NLU model 522 may be used to process a command that requires a guide. In terms of processable tasks, tasks processed by the first NLU model 521 may be a super set of tasks processed by the second NLU model 522. The manufacturer of the electronic device 501 may predefine which tasks are to be performed based on which NLU model. Based on the first NLU model 521 or the second NLU model 522, the electronic device 501 may obtain information regarding a task (e.g., information regarding an application (e.g., a capsule) associated with a task and/or intent information corresponding to a task).

According to an embodiment, based on the information regarding an application (e.g., a capsule) associated with a task and/or intent information corresponding to a task, the electronic device 501 may obtain a list. The obtained list may be any one of the lists stored in the new task list DB 531. FIG. 7 illustrates lists 700 stored in the new task list DB 531. A list 701 may be associated with a task (e.g., a task corresponding to 'answer a call with text'). The list 701 may include information regarding an application (e.g., a capsule) (e.g., a phone application) associated with the task, intent information (e.g., 'Answer a call with text') corresponding to the task, information regarding an OS (e.g., X OS) supporting the task, version information of an application supporting the task (e.g., phone application version x.xx.xx), a pre-condition (e.g., 'the setting for answering a call with text needs to be allowed'), and sub-operations (e.g., 1. Check that you are in a call using the Phone app, 2. Check that text call setting is turned on, and 3. Execute 'Answer Call with Text'). Since a capsule, intent information, a pre-condition, and sub-operations are described in detail with reference to FIG. 5, a repeated description thereof is omitted. A list 702 may be associated with a task (e.g., a task corresponding to 'continue an app on another device'). A list 703 may be associated with a task (e.g., a task corresponding to 'Create a highlight video').

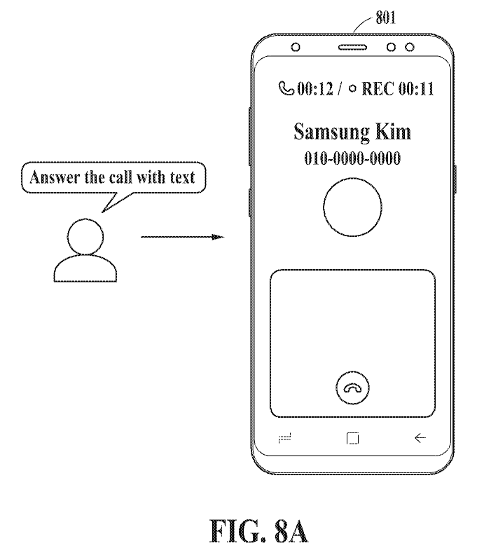

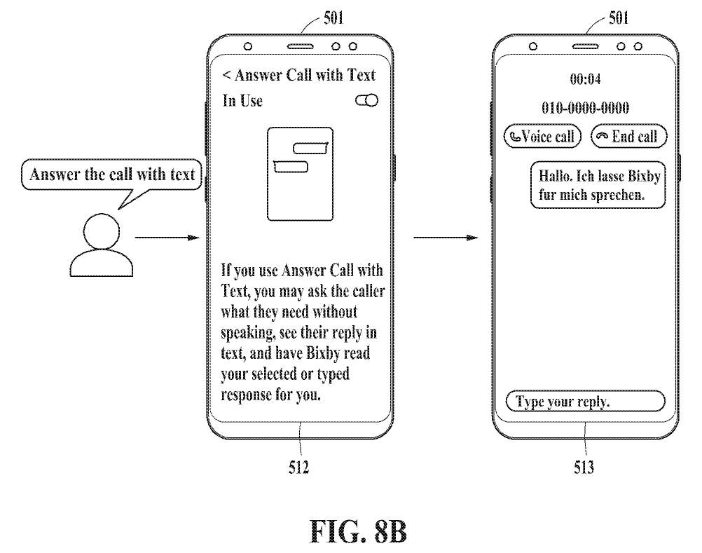

According to an embodiment, pre-conditions may include pre-conditions (e.g., 711, 721, and 722) related to the settings of the electronic device 501. The pre-conditions (e.g., 711, 721, and 722) may be satisfied based on a UI provided to a user based on a deep link. The pre-conditions may include pre-conditions (e.g., 731 and 732) related to data stored in the electronic device 501. The pre-conditions (e.g., 731 and 732) may be satisfied as sub-operations are performed. Descriptions of the pre-conditions and sub-operations are provided in detail with reference to FIGS. 8A, 8B, 9A to 9D, 10A, and 10B.

According to an embodiment, the electronic device 501 may select a list associated with a task by comparing information obtained from the second NLU 522 (e.g., information regarding an application (e.g., a capsule) associated with a task and intent information corresponding to a task) with the information included in the lists 700.

According to an embodiment, based on OS information and application version information included in a list, the electronic device 501 may check whether it (e.g., the electronic device 501) supports a task. The electronic device 501 may check whether it supports a task through an OS check module 523 and an application version check module 524. When the electronic device 501 does not support the task, the electronic device 501 may terminate a session for performing the task. When the electronic device 501 supports the task, the electronic device 501 may maintain a microphone in an activated state throughout a session in which the task is performed (e.g., to continuously receive an input of a user during the session in which the task is performed).

According to an embodiment, the electronic device 501 that supports a task may collect information regarding the electronic device 501 to determine whether pre-conditions are satisfied. Based on the information regarding the electronic device 501, the electronic device 501 may determine whether the pre-conditions are satisfied. To satisfy pre-conditions that are unsatisfied, the electronic device 501 may utilize a pre-condition pre-executor 525 and/or a sub-operation scheduler 526.

According to an embodiment, for pre-conditions that are satisfied based on a UI provided to a user based on a deep link, the electronic device 501 may utilize the pre-condition pre-executor 525. For example, to satisfy the pre-condition 721, the electronic device 501 may execute a deep link to provide the user with a UI (e.g., 511 of FIG. 5).

According to an embodiment, for pre-conditions that are satisfied as sub-operations are performed, the electronic device 501 may utilize the sub-operation scheduler 526. The electronic device 501 may determine (e.g., schedule) which sub-operations are to be performed based on whether the pre-conditions are satisfied. For example, for the pre-condition 731 that is satisfied, the electronic device 501 may determine not to perform a sub-operation 741. For example, for the pre-condition 732 that is unsatisfied, the electronic device 501 may determine to perform a sub-operation 742. Based on a scheduling result, the electronic device 501 may perform at least some of the sub-operations included in a list. Depending on whether the pre-conditions are satisfied, the order in which the electronic device 501 provides UIs may vary.

According to an embodiment, the electronic device 501 may provide a guide to a user throughout a session in which a task is performed. One guide (e.g., a UI) provided by the electronic device 501 may be for satisfying a single pre-condition. The electronic device 501 may selectively provide the user with guides corresponding to the pre-conditions. When a new task is completed at least once according to a guide of the electronic device 501 (e.g., all pre-conditions are satisfied), the electronic device 501, upon receiving a user request for the new task again, may execute the new task immediately. The electronic device 501 may enhance the user experience for the new task.

FIGS. 8A, 8B, 9A to 9D, 10A, 10B, and 11 are diagrams illustrating an operation of an electronic device to process a user utterance, according to various embodiments of the disclosure.

Referring to FIG. 8A, an electronic device 801 may receive an input (e.g., an utterance) (e.g., "Answer the call with text") from a user. The utterance (e.g., "Answer the call with text") may correspond to a task (e.g., a task corresponding to 'answer a call with text') that requires satisfaction of a pre-condition (e.g., the setting for answering a call with text needs to be allowed). The electronic device 801 may determine whether the pre-condition (e.g., the setting for answering a call with text needs to be allowed) is satisfied. The pre-condition (e.g., the setting for answering a call with text needs to be allowed) may be unsatisfied. The electronic device 801 may not perform the task (e.g., the task corresponding to 'answer a call with text'). With the advancement of voice assistant functionality, the number of new tasks that may be performed only when all pre-conditions are satisfied is increasing. Even when a user attempts to perform new tasks through a voice assistant, issues arise where the new tasks are not executed because not all pre-conditions are satisfied.

Referring to FIG. 8B, according to an embodiment, the electronic device 501 may receive an input (e.g., an utterance) (e.g., "Answer the call with text") from the user. The utterance (e.g., "Answer the call with text") may correspond to a task (e.g., a task corresponding to 'answer a call with text') that requires satisfaction of a pre-condition (e.g., the setting for answering a call with text needs to be allowed). The electronic device 501 may determine whether the pre-condition (e.g., the setting for answering a call with text needs to be allowed (e.g., 711 of FIG. 7)) is satisfied. The pre-condition (e.g., the setting for answering a call with text needs to be allowed) may be unsatisfied. To satisfy the pre-condition (e.g., the setting for answering a call with text needs to be allowed), the electronic device 501 may provide the user with a UI 512 (e.g., Answer Call with Text setting screen) based on a deep link. When the user approves the setting for answering a call with text, the electronic device 501 may perform the task (e.g., the task corresponding to 'answer a call with text'). The electronic device 501 may provide the user with a UI 513 (e.g., Answer Call with Text screen).

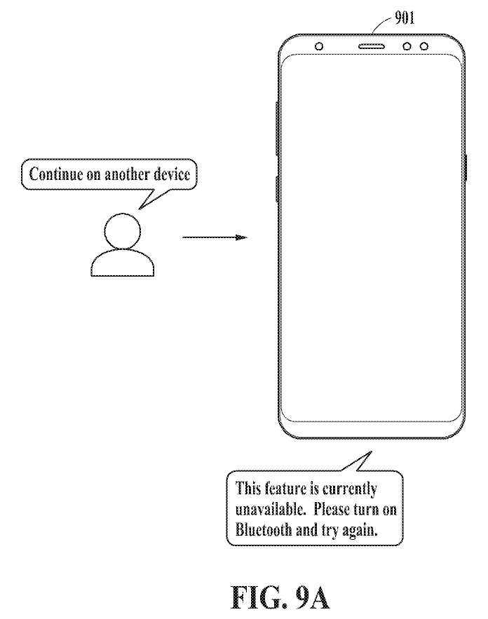

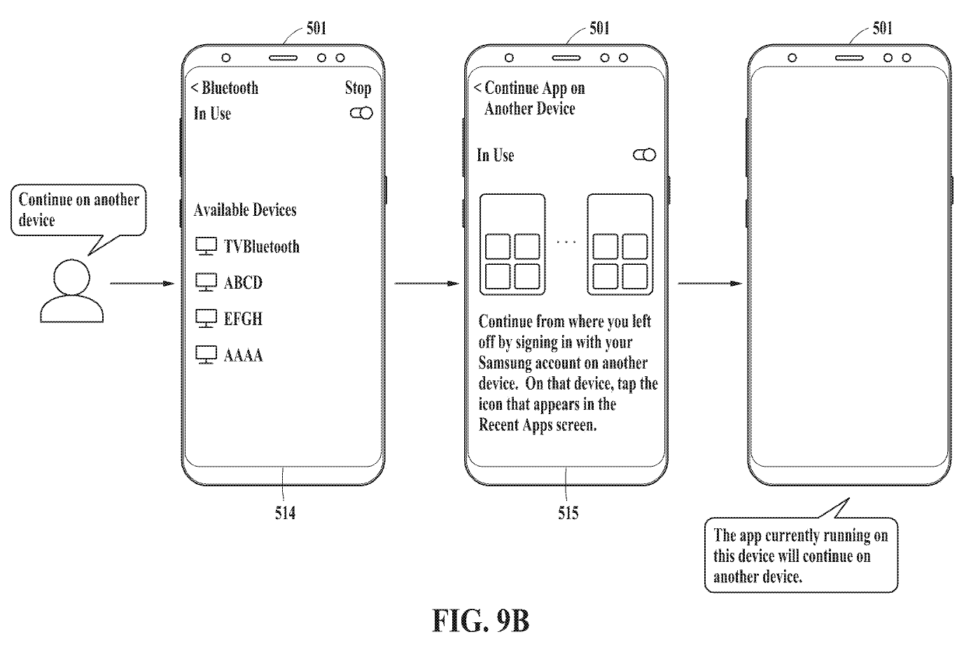

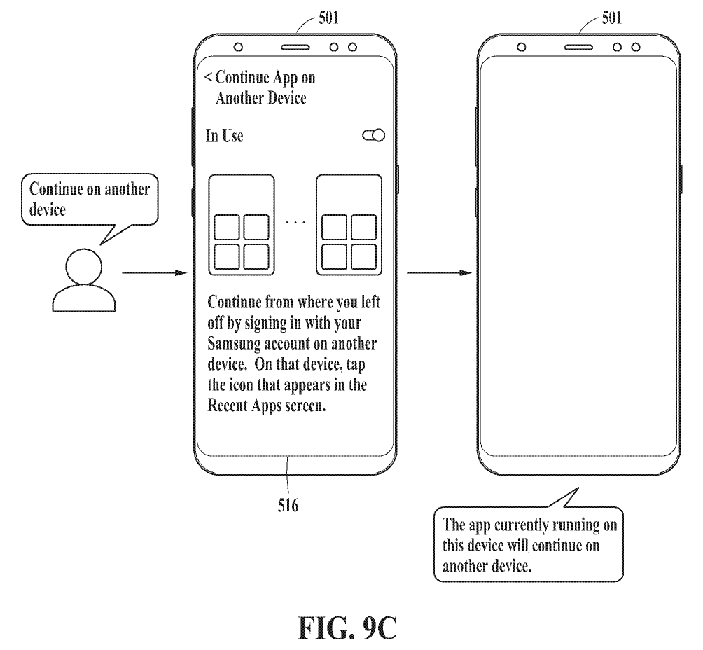

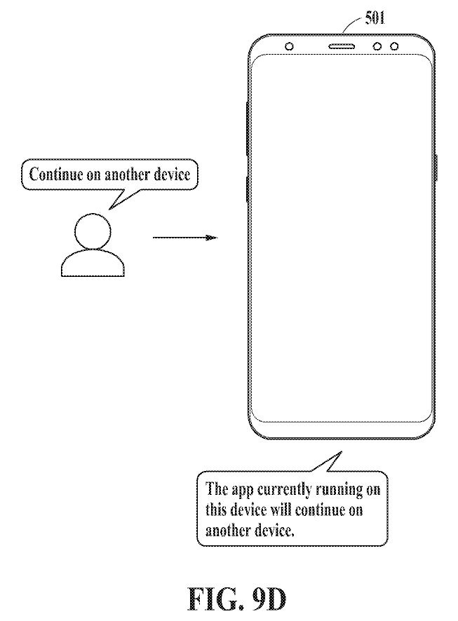

Referring to FIG. 9A, an electronic device 901 may receive an input (e.g., an utterance) (e.g., "Continue on another device") from a user. The utterance (e.g., "Continue on another device") may correspond to a task (e.g., a task corresponding to 'continue an app on another device') that requires satisfaction of pre-conditions (e.g., Bluetooth needs to be turned on (e.g., 721 of FIG. 7) and Continue App on Another Device needs to be turned on (e.g., 722 of FIG. 7)). While performing the task (e.g., the task corresponding to 'continue an app on another device'), the electronic device 901 may need to provide the user with an error message (e.g., This feature is currently unavailable. Please turn on Bluetooth and try again) because the pre-condition 721 is unsatisfied. The electronic device 901 may fail to perform the task.

Referring to FIG. 9B, according to an embodiment, the electronic device 501 may receive an input (e.g., an utterance) (e.g., "Continue on another device") from the user. The utterance (e.g., "Continue on another device") may correspond to a task (e.g., a task corresponding to 'continue an app on another device') that requires satisfaction of pre-conditions (e.g., Bluetooth needs to be turned on (e.g., 721 of FIG. 7) and Continue App on Another Device needs to be turned on (e.g., 722 of FIG. 7)). While performing the task (e.g., the task corresponding to 'continue an app on another device') through a first NLU model (e.g., the first NLU model 521 of FIG. 6), the electronic device 501 may fail to perform the task because the pre-conditions 721 and 722 are unsatisfied. When failing to perform the task through the first NLU model 521, the electronic device 501 may analyze a user input through a second NLU model (e.g., the second NLU model 522 of FIG. 6). The electronic device 501 may determine whether the user input (e.g., an utterance) corresponds to a command (e.g., a command for which a guide is to be provided) processed through the second NLU model 522. When the user input (e.g., an utterance) corresponds to the command processed through the second NLU model 522, the electronic device 501 may continue performing the task (e.g., the task corresponding to 'continue an app on another device') through the second NLU model 522 (e.g., by providing a guide for satisfying pre-conditions and performing sub-operations to satisfy the pre-conditions).

According to an embodiment, the electronic device 501 may provide the user with a UI 514 (e.g., Bluetooth setting screen) based on a deep link to satisfy the pre-condition 721. The electronic device 501 may provide the user with a UI 515 (e.g., Continue App on Another Device setting screen) based on a deep link to satisfy the pre-condition 722. When the user approves all settings, the electronic device 501 may perform the task (e.g., the task corresponding to 'continue an app on another device'). The electronic device 501 may inform the user of a task execution result (e.g., by uttering "The app currently running on this device will continue on another device"). Depending on whether the pre-conditions are satisfied, a UI provided to the user by the electronic device 501 may vary.

Referring to FIG. 9C, according to an embodiment, the pre-condition 721 may be satisfied, while the pre-condition 722 may be unsatisfied. The electronic device 501 may not provide a UI (e.g., Bluetooth setting screen) for satisfying the pre-condition 721. The electronic device 501 may provide the user with a UI 516 (e.g., Continue App on Another Device setting screen) based on a deep link to satisfy the pre-condition 722.

Referring to FIG. 9D, according to an embodiment, the pre-conditions (e.g., 721 and 722) may be satisfied. The electronic device 501 may perform the task (e.g., the task corresponding to 'continue an app on another device'). The electronic device 501 may inform the user of a task execution result (e.g., by uttering "The app currently running on this device will continue on another device").

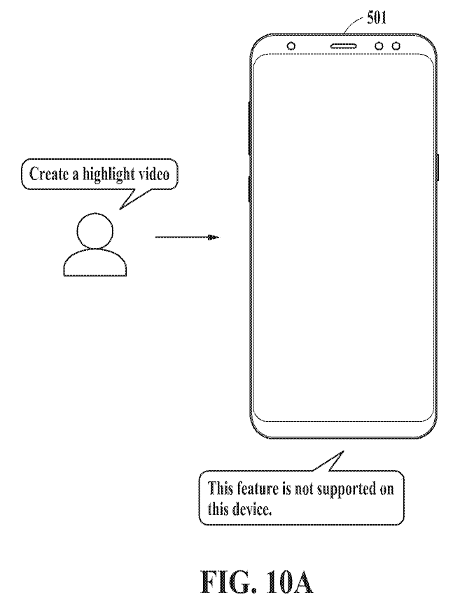

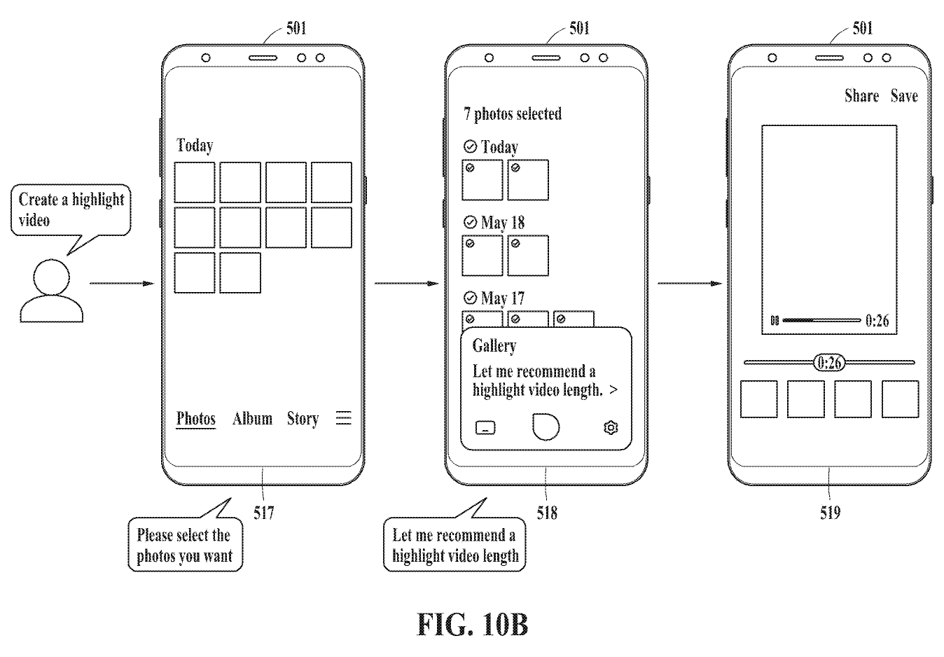

Referring to FIG. 10A, according to an embodiment, before determining whether pre-conditions are satisfied, the electronic device 501 may first check whether it supports a task based on OS information and application version information included in a list. When the electronic device 501 does not support the task, the electronic device 501 may terminate a session for performing the task. The electronic device 501 may inform the user that it does not support the task (e.g., the task corresponding to the utterance "Create a highlight video") (e.g., by uttering "This feature is not supported on this device").

Referring to FIG. 10B, according to an embodiment, when the electronic device 501 supports the task, the electronic device 501 may determine whether pre-conditions (e.g., photos need to be in the gallery app (e.g., 731 of FIG. 7) and photos need to be selected for a highlight video (e.g., 732 of FIG. 7)) that need to be satisfied for the task (e.g., the task corresponding to the utterance "Create a highlight video") are satisfied. For example, the pre-condition 731 may be satisfied, while the pre-condition 732 may be unsatisfied. Based on whether the pre-conditions are satisfied, the electronic device 501 may determine (e.g., schedule) which sub-operations among the sub-operations included in a list (e.g., 703 in FIG. 7) are to be performed. For example, for the pre-condition 731 that is satisfied, the electronic device 501 may determine not to perform a sub-operations741. For example, for the pre-condition 732 that is unsatisfied, the electronic device 501 may determine to perform a sub-operation 742. Based on a scheduling result, the electronic device 501 may perform at least some of the sub-operations included in the list (e.g., 703 in FIG. 7). For example, as the sub-operation 742 is performed, the electronic device 501 may provide the user with a UI 517 (e.g., photo selection screen) and a guide for photo selection (e.g., by uttering "Please select the photos you want"). When the user selects photos such that all pre-conditions (e.g., 731 and 732) are satisfied, the electronic device 501 may perform the task. The electronic device 501 may indicate that the task is completed (e.g., a highlight video is generated) through a UI 518. The electronic device 501 may provide a result of performing the task (e.g., a highlight video) to the user through a UI 519. Depending on whether the pre-conditions are satisfied, a UI provided to the user by the electronic device 501 may vary.

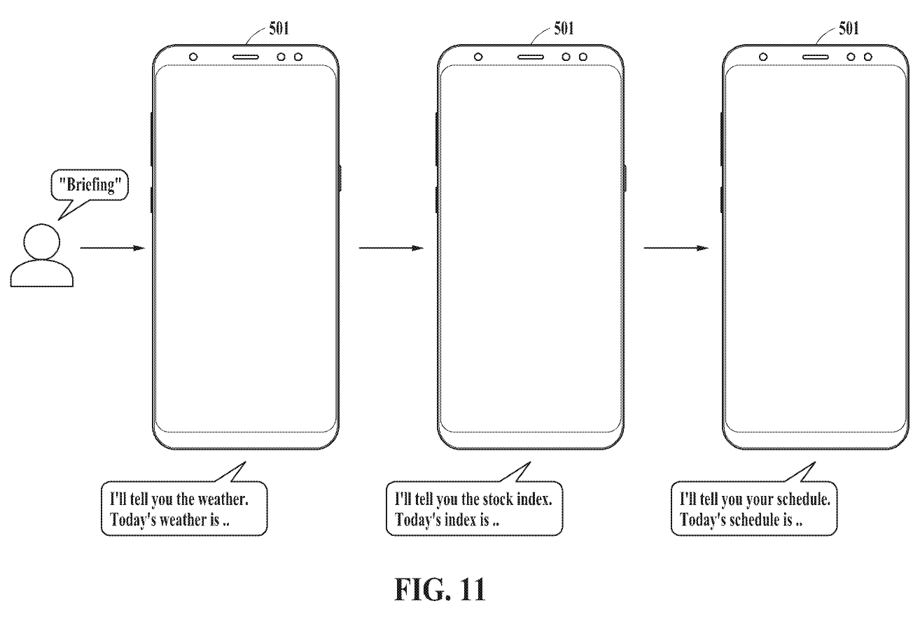

Referring to FIG. 11, according to an embodiment, the electronic device 501 may also process (e.g., support) an input corresponding to a quick command. The quick command may be an input (e.g., an utterance) designated to perform a plurality of tasks. The quick command may be designated by a user. A task may correspond to an action or function performed in response to a user input. The task may be a unit designated by the manufacturer of the electronic device 501 or the like.

According to an embodiment, three tasks, such as "weather notification (a first task)," "stock index notification (a second task)," and "schedule notification (a third task)" may be mapped to a quick command called "Briefing." When the electronic device 501 exactly detects (exactly matched) the quick command "Briefing," the electronic device 501 may sequentially perform the tasks mapped to the quick command. The electronic device 501 may perform the actions for the respective tasks in order. The electronic device 501 may maintain a microphone in an activated state throughout a plurality of sessions in which a plurality of tasks is performed.

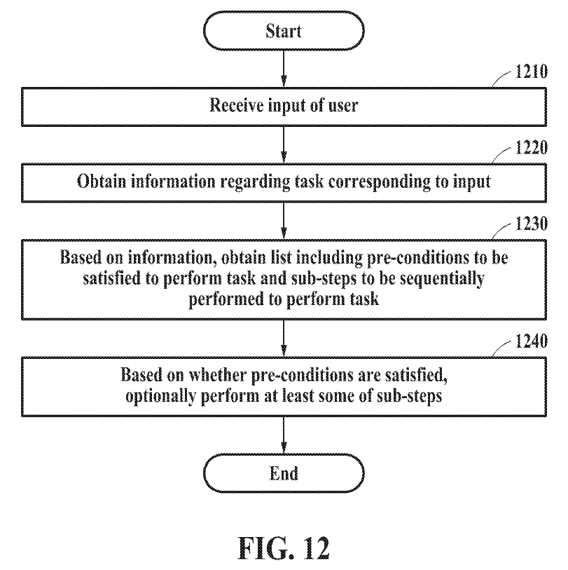

FIG. 12 is a flowchart of a method of operating an electronic device according to an embodiment of the disclosure.

Operations 1210 to 1240 may be performed sequentially but not necessarily. For example, the order of the operations 1210 to 1240 may change, and at least two of the operations may be performed in parallel.

According to an embodiment, it may be understood that operations 1210 to 1240 may be performed by a processor (e.g., the processor 520 of FIG. 6) of an electronic device (e.g., the electronic device 501 of FIG. 5).

In operation 1210, the electronic device (e.g., the electronic device 501 of FIG. 5) according to an embodiment may receive an input of a user.

In operation 1220, the electronic device according to an embodiment may obtain information regarding a task corresponding to the input.

In operation 1230, based on the information, the electronic device according to an embodiment may obtain a list including pre-conditions to be satisfied to perform the task and sub-operations to be sequentially performed to perform the task.

In operation 1240, based on whether the pre-conditions are satisfied, the electronic device according to an embodiment may optionally perform at least some of the sub-operations.

According to an embodiment, when the electronic device fails to perform an operation while performing a task determined through a first NLU model (e.g., the first NLU model 521 of FIG. 6) (e.g., because pre-conditions are unsatisfied), the operation may be performed based on a second NLU model (e.g., the second NLU model 522 of FIG. 6).

According to an embodiment, depending on whether pre-conditions are satisfied, the sub-operations performed by the electronic device may vary. Depending on whether pre-conditions are satisfied, a UI (e.g., a guide) provided by the electronic device may vary. One guide (e.g., a UI) provided by the electronic device may be intended to fulfill one pre-condition. The electronic device may selectively provide a user with guides corresponding to pre-conditions.

According to an embodiment, the electronic device may provide a guide to the user throughout a session in which a task is performed. When a new task is completed at least once according to the guide provided by the electronic device (e.g., when all pre-conditions are satisfied), the electronic device, upon receiving a user request for the new task again, may immediately perform the task. The electronic device may enhance the user experience for new tasks.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, "A or B," "at least one of A and B," "at least one of A or B," "A, B or C," "at least one of A, B and C," and "at least one of A, B, or C," each of which may include any one of the items listed together in the corresponding one of the phrases, or all possible combinations thereof. Terms such as "first" or "second" may be used to simply distinguish a corresponding component from other components, and do not limit the components in other aspects (e.g., importance or order). It is to be understood that if an element (e.g., a first element) is referred to, with or without the term "operatively" or "communicatively," as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware and may interchangeably be used with other terms, for example, "logic," "logic block," "part," or "circuitry." A module may be a single integral component, or a minimum unit or part thereof, adapted to perform one or more functions. For example, according to an embodiment, the module may be implemented in a form of an application-specific integrated circuit (ASIC).

Various embodiments of the document may be implemented as software (e.g., a program) including one or more instructions stored in a storage medium (e.g., internal memory or external memory) readable by a machine (e.g., an electronic device). For example, a processor (e.g., a processor) of the machine (e.g., the electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore^{TM}), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

A method of operating an electronic device (e.g., the electronic device 101 of FIG. 1, the electronic device 201 of FIG. 2, or the electronic device 501 of FIG. 5) according to an embodiment may include receiving an input of a user. The method may include obtaining information regarding a task corresponding to the input. The method may include, based on the information, obtaining a list including pre-conditions to be satisfied to perform the task and sub-operations to be sequentially performed to perform the task. The method may include, based on whether the pre-conditions are satisfied, optionally performing at least some of the sub-operations.

According to an embodiment, the information may include information regarding an application associated with the task and intent information corresponding to the task, and the information may be obtained by one of two NLU models.

According to an embodiment, the list may further include information regarding an application associated with the task, intent information corresponding to the task, information regarding an OS supporting the task, and version information of an application supporting the task.

According to an embodiment, the method may further include, based on OS information and application version information included in the list, checking whether the electronic device supports the task. The method may further include, when the electronic device does not support the task, terminating a session for performing the task.

According to an embodiment, the pre-conditions may include a condition related to a setting of the electronic device and a condition related to data stored in the electronic device.

According to an embodiment, the pre-conditions may be satisfied based on a UI provided to the user based on a deep link. The pre-conditions may be satisfied as a sub-operation is performed.

According to an embodiment, the optionally performing may include collecting information regarding the electronic device to determine whether the pre-conditions are satisfied. The optionally performing may include, based on the information regarding the electronic device, determining whether the pre-conditions are satisfied.

According to an embodiment, the optionally performing may further include, based on whether the pre-conditions are satisfied, scheduling sub-operations to be performed among the sub-operations. The optionally performing may further include, based on a scheduling result, performing the at least some of the sub-operations.

According to an embodiment, the electronic device may maintain a microphone in an activated state throughout a session in which the task is performed.

According to an embodiment, the input may include a quick command designated to perform a plurality of tasks. The electronic device may maintain a microphone in an activated state throughout a plurality of sessions in which the plurality of tasks is performed.

An electronic device (e.g., the electronic device 101 of FIG. 1, the electronic device 201 of FIG. 2, or the electronic device 501 of FIG. 5) according to an embodiment may include a processor (e.g., the processor 120 of FIG. 1, the processor 203 of FIG. 2, or the processor 520 of FIG. 5) and memory (e.g., the memory 130 of FIG. 1, the memory 207 of FIG. 2, or the memory 530 of FIG. 5) storing instructions. The instructions, when executed by the processor individually or collectively, may cause the electronic device to receive an input of a user. The instructions, when executed by the processor individually or collectively, may cause the electronic device to obtain information regarding a task corresponding to the input. The instructions, when executed by the processor individually or collectively, may cause the electronic device to, based on the information, obtain a list including pre-conditions to be satisfied to perform the task and sub-operations to be sequentially performed to perform the task. The instructions, when executed by the processor individually or collectively, may cause the electronic device to, based on whether the pre-conditions are satisfied, optionally perform at least some of the sub-operations.

According to an embodiment, the information may include information regarding an application associated with the task and intent information corresponding to the task, and the information is obtained by one of two NLU models.

According to an embodiment, the list may further include information regarding an application associated with the task, intent information corresponding to the task, information regarding an OS supporting the task, and version information of an application supporting the task.

According to an embodiment, the instructions, when executed by the processor individually or collectively, may cause the electronic device to, based on OS information and application version information included in the list, check whether the electronic device supports the task. The instructions, when executed by the processor individually or collectively, may cause the electronic device to, when the electronic device does not support the task, terminate a session for performing the task.

According to an embodiment, the pre-conditions may include a condition related to a setting of the electronic device and a condition related to data stored in the electronic device.

According to an embodiment, the pre-conditions may be satisfied based on a UI provided to the user based on a deep link. The pre-conditions may be satisfied as a sub-operation is performed.

According to an embodiment, the instructions, when executed by the processor individually or collectively, may cause the electronic device to collect information regarding the electronic device to determine whether the pre-conditions are satisfied. The instructions, when executed by the processor individually or collectively, may cause the electronic device to, based on the information regarding the electronic device, determine whether the pre-conditions are satisfied.

According to an embodiment, the instructions, when executed by the processor individually or collectively, may cause the electronic device to, based on whether the pre-conditions are satisfied, schedule sub-operations to be performed among the sub-operations. The instructions, when executed by the processor individually or collectively, may cause the electronic device to, based on a scheduling result, perform the at least some of the sub-operations.

According to an embodiment, the electronic device may maintain a microphone in an activated state throughout a session in which the task is performed.

According to an embodiment, the input may include a quick command designated to perform a plurality of tasks. The electronic device may maintain a microphone in an activated state throughout a plurality of sessions in which the plurality of tasks is performed.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
receiving, by the electronic device, an input of a user;
obtaining, by the electronic device, information regarding a task corresponding to the input;
based on the information, obtaining, by the electronic device, a list comprising pre-conditions to be satisfied to perform the task and sub-operations to be sequentially performed to perform the task; and
based on whether the pre-conditions are satisfied, optionally performing, by the electronic device, at least some of the sub-operations.

2. The method of claim 1, wherein the information comprises information regarding an application associated with the task and intent information corresponding to the task, and the information is obtained by one of two natural language understanding (NLU) models.

3. The method of any one of claim 1, further comprising:
based on operating system (OS) information and application version information comprised in the list, checking whether the electronic device supports the task, and
when the electronic device does not support the task, terminating a session for performing the task.

4. The method of claim 1,
wherein the pre-conditions comprise a condition related to a setting of the electronic device and a condition related to data stored in the electronic device, and
wherein the pre-conditions are:
satisfied based on a user interface (UI) provided to the user based on a deep link, or
satisfied as a sub-operation is performed.

5. The method of claim 1, wherein the optionally performing comprises:
collecting information regarding the electronic device to determine whether the pre-conditions are satisfied; and
based on the information regarding the electronic device, determining whether the pre-conditions are satisfied.

6. The method of claim 1, wherein the optionally performing further comprises:
based on whether the pre-conditions are satisfied, scheduling sub-operations to be performed among the sub-operations; and
based on a scheduling result, performing the at least some of the sub-operations.

7. The method of claim 1, wherein the electronic device maintains a microphone in an activated state throughout a session in which the task is performed.

8. The method of claim 1,
wherein the input comprises a quick command designated to perform a plurality of tasks, and
wherein the electronic device maintains a microphone in an activated state throughout a plurality of sessions in which the plurality of tasks is performed.

9. An electronic device comprising:
memory, comprising one or more storage media, storing instructions; and
one or more processors communicatively coupled to the memory,
wherein the instructions, when executed by the one or more processors individually or collectively, cause the electronic device to:
receive an input of a user,
obtain information regarding a task corresponding to the input,
based on the information, obtain a list comprising pre-conditions to be satisfied to perform the task and sub-operations to be sequentially performed to perform the task, and
based on whether the pre-conditions are satisfied, optionally perform at least some of the sub-operations.

10. The electronic device of claim 9, wherein the information comprises information regarding an application associated with the task and intent information corresponding to the task, and the information is obtained by one of two natural language understanding (NLU) models.

11. The electronic device of claim 9, wherein the instructions, when executed by the one or more processors individually or collectively, further cause the electronic device to:
based on operating system (OS) information and application version information comprised in the list, check whether the electronic device supports the task; and
when the electronic device does not support the task, terminate a session for performing the task.

12. The electronic device of claim 9,
wherein the pre-conditions comprise a condition related to a setting of the electronic device and a condition related to data stored in the electronic device, and
wherein the pre-conditions are:
satisfied based on a user interface (UI) provided to the user based on a deep link, or
satisfied as a sub-operations is performed.

13. The electronic device of claim 9, wherein the instructions, when executed by the one or more processors individually or collectively, further cause the electronic device to:
collect information regarding the electronic device to determine whether the pre-conditions are satisfied; and
based on the information regarding the electronic device, determine whether the pre-conditions are satisfied.

14. The electronic device of claim 9, wherein the instructions, when executed by the one or more processors individually or collectively, cause the electronic device to:
based on whether the pre-conditions are satisfied, schedule sub-operations to be performed among the sub-operations; and
based on a scheduling result, perform the at least some of the sub-operations.

15. The electronic device of claim 9,
wherein the electronic device maintains a microphone in an activated state throughout a session in which the task is performed, or
wherein the electronic device maintains a microphone in an activated state throughout a plurality of sessions in which a plurality of tasks is performed when the input comprises a quick command designated to perform the plurality of tasks.

16. One or more non-transitory computer-readable storage media storing one or more computer programs including computer-executable instructions that, when executed by one or more processors of an electronic device individually or collectively, cause the electronic device to perform operations, the operations comprising:
receiving, by the electronic device, an input of a user;
obtaining, by the electronic device, information regarding a task corresponding to the input;
based on the information, obtaining, by the electronic device, a list comprising pre-conditions to be satisfied to perform the task and sub-operations to be sequentially performed to perform the task; and
based on whether the pre-conditions are satisfied, optionally performing, by the electronic device, at least some of the sub-operations.

17. The one or more non-transitory computer-readable storage media of claim 16, wherein the information comprises information regarding an application associated with the task and intent information corresponding to the task, and the information is obtained by one of two natural language understanding (NLU) models.

18. The one or more non-transitory computer-readable storage media of claim 16, the operations further comprising:
based on operating system (OS) information and application version information comprised in the list, checking whether the electronic device supports the task, and
when the electronic device does not support the task, terminating a session for performing the task.

19. The one or more non-transitory computer-readable storage media of claim 16,
wherein the pre-conditions comprise a condition related to a setting of the electronic device and a condition related to data stored in the electronic device, and
wherein the pre-conditions include:
satisfied based on a user interface (UI) provided to the user based on a deep link, or
satisfied as a sub-operation is performed.

20. The one or more non-transitory computer-readable storage media of claim 16, wherein the optionally performing comprises:
collecting information regarding the electronic device to determine whether the pre-conditions are satisfied; and
based on the information regarding the electronic device, determining whether the pre-conditions are satisfied.
